(19) United States
(12) Patent Application Publication
(10) Pub. No.: US 2026/0072338 A1
(43) Pub. Date: Mar. 12, 2026

(54) CAMERA MODULE AND MOBILE DEVICE

(71) Applicants: YIBIN TINNO COMMUNICATION CO, LTD, Yibin City, Sichuan (CN); SHENZHEN TINNO WIRELESS TECHNOLOGY CO., LTD, Shenzhen, Guangdong (CN)

(72) Inventor: Chongxi BAI, Shenzhen (CN)

(21) Appl. No.: 18/864,007

(22) PCT Filed: Jan. 4, 2023
(86) PCT No.: PCT/CN2023/070418

§ 371 Date: Nov. 8, 2024

(30) Foreign Application Priority Data
Dec. 30, 2022 (CN) 202211732710.4

(51) Int. Cl. G03B 30/00; G03B 15/03

(52) U.S. Cl. CPC G03B 30/00; G03B 15/03

(57) ABSTRACT

The present invention relates to the technical field of electronic devices, in particular to a camera module, applied in a mobile device, characterized in that it comprises: a camera module having at least three lenses; a drive module having a transmission mechanism and a limiting mechanism, the transmission mechanism including a first transmission unit and a second transmission unit cooperating with the first transmission unit, the camera module being connected to the drive module to drive the camera module to do a linear sliding movement and a horizontal rotation movement; the limiting mechanisms being magnetically accessible to each other close to or far from each other; and a rotary module, the rotary module is provided between the drive modules, so that the first transmission unit and the second transmission unit are connected, and the second transmission unit is rotated horizontally in movement.

### TECHNICAL FIELD

The present invention relates to the technical field of electronic devices, and in particular to a camera module and a mobile device.

### BACKGROUND ART

With the rapid development of information technology, the use of device products (e.g., cell phones, tablets, and laptops) is becoming more and more frequent, and more and more applications are being integrated into the devices, among them, taking pictures has become one of the necessary applications of the device product, and in order to realize the selfie function, a front camera is often set up in the device product, and the front camera is set up on the surface where the display surface of the device product is located in order to realize the selfie function, but because the front camera is located on the side where the display screen of the device product is located, so that the display surface of the device product is required to reserve the window for the front camera to take pictures, that is, the front camera will occupy the display area, making it difficult to realize a full-screen.

Full-screen is the inevitable trend of today's cell phone development, whether it is a single full-screen, or folding form of the full-screen, the ultimate form of the future phone must be a higher and higher screen-to-body ratio, infinitely close to 100% screen-to-body ratio. At present, the full-screen has been developed to the point that the distance sensor and the earpiece can be hidden on the bezel, and the light sensor can be hidden under the screen by utilizing the translucency of organic light-emitting diodes (Organic Light-Emitting Diode, OLED), and the only thing that stops the full-screen from continuing to evolve is the concealment of the front-facing camera. Before the commercialization of the under-screen camera, fringe, water drop, hollow screen and other shaped screens have been widely available in the market; periscope, slide and sliding camera also have some manufacturers of the listed models, the main purpose of these designs are to hide the front camera. However, the shaped screen can be the to be only a pseudo-comprehensive screen; periscope type, slide type and slide cover type have many shortcomings, such as large thickness of the body, taking up a lot of space on the motherboard, battery capacity is small, the slide type and slide cover type exist perpendicular to the sliding direction of the absences, the stand-alone cost increases, the structure of the rigidity of the poor, difficult to pass the drop test, the difficulty of improving the yield of the assembly and other shortcomings. Before the full maturity of the under-screen camera, the full-screen solution with a simple and stable structure, small internal space occupation, and low cost and easy to realize will become the mainstream design solution for the full-screen in this excessive stage.

### CONTENT OF THE INVENTION

In view of the above drawbacks of the prior art, an object of the present invention is to provide a camera module and a mobile device to solve the drawbacks of the prior art such as increased cost of a single camera, poor structural rigidity, difficulty in passing a drop test, and difficulty in improving the assembly yield.

To achieve the above purpose and other related purposes, in a first aspect, the present application provides a camera module, applied in a mobile device, comprising:
A camera module having at least three lenses;
A drive module, comprising a transmission mechanism, a limiting mechanism, and a rotary module, for connecting the camera module to drive the camera module in a linear sliding movement and a horizontal rotation movement;
wherein the transmission mechanism drives the rotary module to cause the camera module to perform a horizontal rotation movement.

further, the transmission mechanism comprises a first transmission unit and a second transmission unit cooperating with the first transmission unit, the limiting mechanism comprising at least two first magnets and at least two second magnets, at least the two first magnets being disposed in the first transmission unit, at least the two second magnets are provided in the mobile device, at least the two first magnets and at least the two second magnets are provided side by side and at least the two first magnets and at least the two second magnets are magnetically movable close to or far from each other.

further, the rotary module is provided between the drive modules such that the first transmission unit and the second transmission unit are connected and such that the second transmission unit is subjected to horizontal rotation movement.

Further, the camera module is provided with at least a first lens, a second lens, and a third lens, respectively, a fixed focal length lens, a zoom lens, a shorter focal length lens, a longer focal length lens, a wide-angle zoom lens, and an ultra-wide-angle lens in any combination of lenses; the first lens and the second lens are provided on the second transmission unit; the third lens is provided on the first transmission unit.

Further, the camera module further comprises a flashlight, the flashlight is set on the first transmission unit.

further, the drive module further comprises a power mechanism, the power unit transmits power through the first transmission unit and the second transmission unit to drive the camera module to do linear sliding movement and horizontal rotation movement in sequence.

Further, in the process of the camera module doing linear sliding movement, manually controlling sliding the first transmission unit and the second transmission unit to do linear sliding movement; in the process of the camera module doing horizontal rotation movement, manually controlling sliding the first transmission unit to do linear sliding movement and manually controlling rotating the second transmission unit to do horizontal rotation movement.

further, the limiting mechanism is capable of enabling a linear sliding movement of the transmission mechanism between a first position and a second position for realizing the switching of the camera module between a rear-focused state and a front-focused state.

further, the at least two first magnets and the at least two second magnets are, but not limited to, neodymium iron boron permanent magnets.

In a second aspect, the present application provides a mobile device, the mobile device using a camera module as described in the first aspect, and provided with a display screen and a back cover, the back cover comprising a movable part, the display screen being fixedly connected to the back cover, the movable part being connected to the drive module, an outer surface of the camera module being spliced together with the back cover to form an outer surface of the mobile device, the drive module for driving the camera module in a linear sliding movement and a horizontal rotation movement, so that the camera module has the functions of both a rear camera and a front camera, and during the process of driving the camera module lift and lower by the drive module, the movable part is synchronously lifted and lowered together with the drive module.

As described above, a camera module and a mobile device, by incorporating the sliding of the camera module and the driving module, solves a simple and low-cost way of realizing a full-screen until the under-screen camera completes its maturity and the cost drops, and has at least the following beneficial effects:

The present invention realizes a full screen while minimizing the occupation of space inside the cell phone, and on this basis, ensures structural rigidity and stability for long-term use, reduces the difficulty of assembly, and ensures the production yield of the solution. The dual cameras of the three cameras rotating around the central axis can be rotated to be used as a front camera, eliminating the cost of front camera materials, while realizing the protection of user privacy at the physical level.

The present invention in the perpendicular to the sliding direction of the displacement suppression, the front camera sliding module is stuck in the back cover, can avoid the phone sliding time after a long time of vertical sliding direction of the missing and shaking. At the same time for the occupancy of space inside the body, and the traditional “bathtub” design of the cell phone space occupancy difference is not great, but also eliminates the space of the front camera.

This invention through the neodymium iron boron permanent magnet to realize manual sliding, simplify the mechanical structure at the same time, reduce the difficulty of assembly, improve the assembly yield, and reduce the cost of a single machine.

This invention only makes the camera module into a small sliding module by using neodymium iron boron permanent magnets, and at the same time joins the rotation mechanism of the rear dual camera, which is a low-cost, small space occupation inside the body, and structural strength can be guaranteed to realize the full-screen solution.

### BRIEF DESCRIPTION OF THE DRAWINGS

FIG. 1 is a schematic diagram of a structure of a camera module in an exemplary embodiment of the present application

FIG. 2 is a three-dimensional schematic diagram of a mobile device in a first direction in an exemplary embodiment of the present application;

FIG. 3 is a three-dimensional schematic diagram of a mobile device in a second direction in an exemplary embodiment of the present application;

FIG. 4 is a schematic diagram of a front camera of a camera module in an exemplary embodiment of the present application;

FIG. 5 is a schematic diagram of a rear camera of a camera module in an exemplary embodiment of the present application;

FIG. 6 is a schematic diagram of a limiting mechanism of a camera module in an exemplary embodiment of the present application.

### DETAILED DESCRIPTION OF THE EMBODIMENTS

The technical solutions in the embodiments of the present application will be described clearly and completely in the following in conjunction with the accompanying drawings in the embodiments of the present application, and it is obvious that the described embodiments are a part of the embodiments of the present application, not all of the embodiments. Based on the embodiments in this application, all other embodiments obtained by a person of ordinary skill in the art without creative labor fall within the scope of protection of this application.

It should be noted that the structure, proportion, size, etc. shown in the drawings attached to this specification are only used to match the content of the specification for people familiar with the technology to understand and read, and are not used to limit the implementation of the present invention, so they do not have the technical significance of the modification of the structure, the proportion of the relationship between the changes in the size of the adjustments, without affecting the efficacy of the present invention and the purpose of the invention, should still fall within the scope of this application. Meanwhile, the terms such as “top”, “bottom”, “left”, “right”, “center” and “first”, “second”, etc. cited in this specification are only for the convenience of narrative clarity and are not intended to limit the scope of the implementable invention, changes or adjustments in their relative relationships are considered to be within the scope of the present invention without substantially changing the technical content.

The present application provides a camera module that can be applied in various devices, including but not limited to being used in, for example, a cell phone, a tablet, a laptop, and the like.

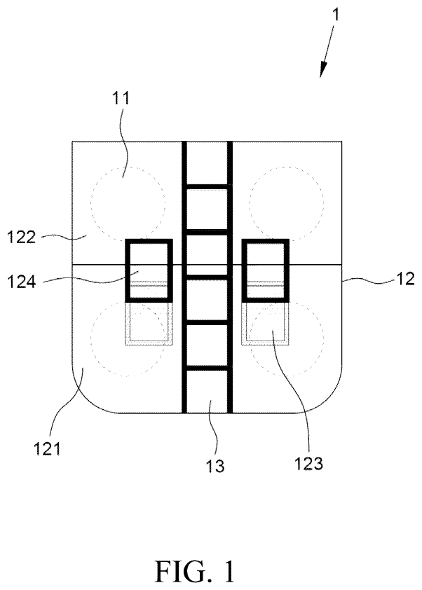

In an embodiment, referring to FIG. 1, the present embodiment provides a camera module 1 and applies it in a mobile device 2.

As a preferred embodiment, the camera module 1 comprises: a camera module 11 having at least three lenses; a drive module 12 having a transmission mechanism and a limiting mechanism, the transmission mechanism comprising a first transmission unit 121 and a second transmission unit 122 cooperating with the first transmission unit 121.

In this embodiment, the camera module 11 is connected with the drive module 12 to drive the camera module 11 to perform linear sliding movement and horizontal rotation movement; the limiting mechanism includes at least two first magnets 123 and at least two second magnets 124, the at least two first magnets 123 are set in the first transmission unit 121, the at least two second magnets 124 are set in the mobile device 2, the at least two first magnets 123 and the at least two second magnets 124 being disposed side by side and the at least two first magnets 123 and the at least two second magnets 124 being magnetically close to each other or far from each other; and a rotary module 13, the rotary module 13 being disposed between the drive module 12, connecting the first transmission unit 121 with the second transmission unit 122 and causing the second transmission unit 122 to move in a horizontal rotation movement.

As a preferred embodiment, the camera module 11 further comprises a flashlight, the camera module 11 is provided with at least a first lens, a second lens, and a third lens, the first lens and the second lens are set on the second transmission unit 122; the third lens and the flashlight set on the first transmission unit 121.

Further preferred in this embodiment, the first lens, the second lens, and the third lens, respectively, are a fixed focal length lens, a zoom lens, a shorter focal length lens, a longer focal length lens, a wide-angle zoom lens, and an ultra-wide-angle lens any combination of lenses.

As a preferred embodiment of the present embodiment, the drive module 12 further comprises a power mechanism, the power unit transmits power through the first transmission unit 121 and the second transmission unit 122 to drive the camera module 11 to do linear sliding movement and horizontal rotation movement in turn.

As a preference of this embodiment, the layout of the camera module 11 adopts a “bathtub” type design, the first lens and the second lens of the upper part of the camera module 11 are a prime lens and a wide-angle lens, and the third lens of the lower part of the camera module 11 is a telephoto lens and a flashlight.

As a preferred embodiment, the upper part of the camera module 11 is connected to the second transmission unit 122 of the drive module 12, and the lower part of the camera module 11 is connected to the first transmission unit 121 of the drive module 12, wherein the first transmission unit 121 and the transmission unit have the rotary module 13 in the middle of the first transmission unit 121 and the transmission unit, and after sliding the upper part of the camera out along the limiting mechanism, the two cameras of the upper part can be rotated to realize a front camera.

In one embodiment, during the linear sliding movement of the camera module 11, when the power unit drives the first transmission unit 121 in a linear sliding movement, the first transmission unit 121 drives the second transmission unit 122 in a linear sliding movement; in the process of horizontal rotation movement of the camera module 11, the power unit drives the first transmission unit 121 to do linear sliding movement, and the first transmission unit 121 drives the rotary module 13 to make the second transmission unit 122 to do horizontal rotation movement.

In this embodiment, the limiting mechanism is capable of enabling the transmission mechanism to make a linear sliding movement between the first position and the second position, and the limiting mechanism is used to realize the switching of the camera module 11 between a rear-focused state and a front-focused state.

As a preferred embodiment, the at least two first magnets 123 and the at least two second magnets 124 are, but not limited to, neodymium iron boron permanent magnets.

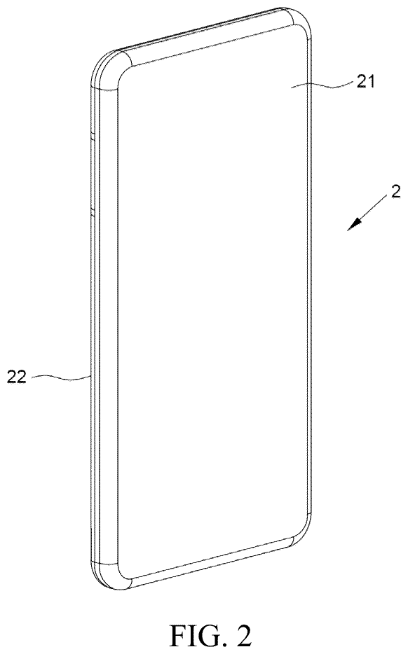

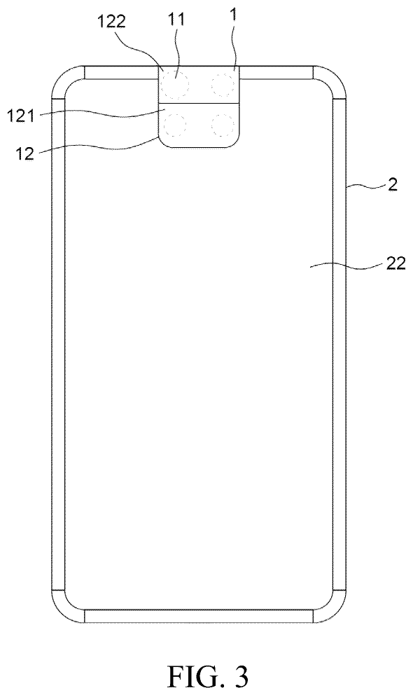

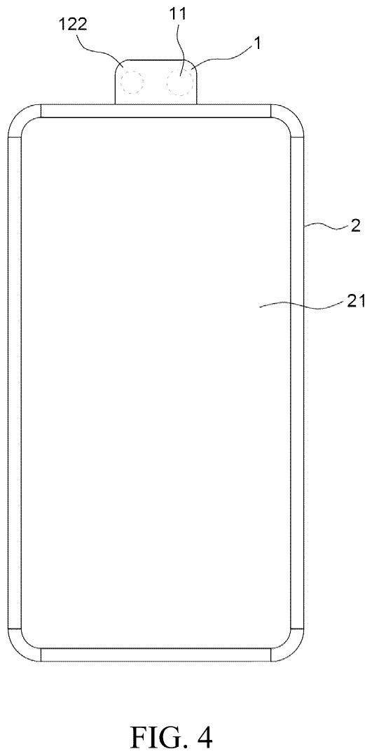

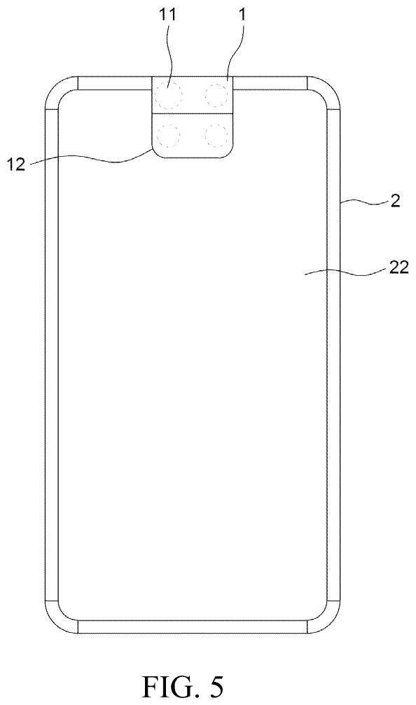

In another embodiment, referring to FIG. 2-FIG. 5, this embodiment provides a mobile device 2 comprising a camera module 1, and a display screen 21, a back cover 22.

As a preferred embodiment, the back cover 22 comprises a movable part 221, the display screen 21 is fixedly connected to the back cover 22, the movable part 221 is connected to the drive module 12, and the outer surface of the camera module 1 and the back cover 22 are connected together to form the outer surface of the mobile device 2.

In this embodiment, the drive module 12 is used to drive the camera module 11 in a linear sliding movement and a horizontal rotation movement, so that the camera module 1 has the functions of both a rear camera and a front camera, and during the process of driving the camera module 11 lift and lower by the drive module 12, the movable part 221 is synchronized to be lifted and lowered together with the drive module 12.

In an embodiment, the present embodiment carries out a specific operation description, when a user needs to use the rear camera shooting function of the mobile device 2, a first control command can be sent to the mobile device 2, and the mobile device 2 sends a first execution command to the drive module 12 after receiving the first control command to drive the camera module 11.

After receiving the first control command, the mobile device 2 sends a first control command to the drive module 12, which sends a first execution command to drive the camera module 11 to do a linear sliding movement, and after the drive module 12 receives the first execution command, the power unit drives the first transmission unit 121 to do a linear sliding movement and the first transmission unit 121 drives the second transmission unit 122 to do a linear sliding movement, and the user can use the rear camera function of the mobile device 2;

In the preferred implementation of this embodiment, when the user needs to use the shooting function of the mobile device 2, the first control command can be sent to the mobile device 2, and the user can use the rear camera function of the mobile device 2.

In the preferred implementation of this embodiment, when the user needs to use the front camera shooting function of the mobile device 2, a second control command may be issued to the mobile device 2, and the mobile device 2 receives the second control command and sends a second execution command to the drive module 12, at this time, the power unit drives the first transmission unit 121 to perform a linear sliding movement, and the first transmission unit 121 drives the rotary module 13 to make the second transmission unit 122 perform a horizontal rotation movement, so that the user can normally use the front camera function of the mobile device 2;

In the preferred implementation of this embodiment, in the process of the camera module 11 doing horizontal rotation movement, manually controlling sliding the first transmission unit 121 to do linear sliding movement, and manually controlling rotating the second transmission unit 122 to do horizontal rotation movement.

The present embodiment reduces the sliding portion of the conventional slide-type or slide-cover-type to that of only the front camera, and both the slide-type and the slide-cover-type are only for exposing the front camera. Therefore, making the front camera into a slidable mechanism alone can ensure the maximum integrity of the structural design of the whole machine while realizing a full-screen, and when there is a front camera use scene, the drive module 12 lifts the lens and then makes the rotary module 13 rotate, so that the rear camera can be realized to be used as a front camera.

This embodiment of the rear of the limiting mechanism occupies a sufficiently small volume, through the neodymium iron boron permanent magnet structure to realize the manual slide out and slide in, the rotary module 13 is also used to manually rotate the shaft, to realize the rear camera to the front camera shift. Survey data shows that the ratio of front and rear camera use in cell phones is about 3:7, and in some game phones and other similarly positioned cell phones, this ratio is even lower.

Therefore, the manual slide-out design of this embodiment will not bring too much impact on the convenience of the user. At the same time, the use of the front camera is mostly for video calls and selfies, and there is no emergency use of the rear camera that requires snapshots, so for the front camera, the requirement for the swiftness of sliding is not particularly high. In the perpendicular to the sliding direction of the displacement suppression, the front camera sliding module is stuck in the back cover inside, can avoid the phone sliding time after a long time of vertical sliding direction of the amount of waste and shaking. At the same time for the occupation of space inside the body, and the traditional “bathtub” design of the cell phone space occupation is not very different, but also eliminates the space of the front camera.

Further, the sliding portion in this embodiment adopts a very small sliding structure to reduce the occupation of the internal space of the cellular phone, to ensure that the thickness of the cellular phone is controlled and the battery capacity is guaranteed. The sliding structure is realized by means of a neodymium-iron-boron permanent magnet to realize manual sliding, which simplifies the mechanical structure while reducing the difficulty of assembly, improving the assembly yield, and at the same time reducing the cost of a single machine.

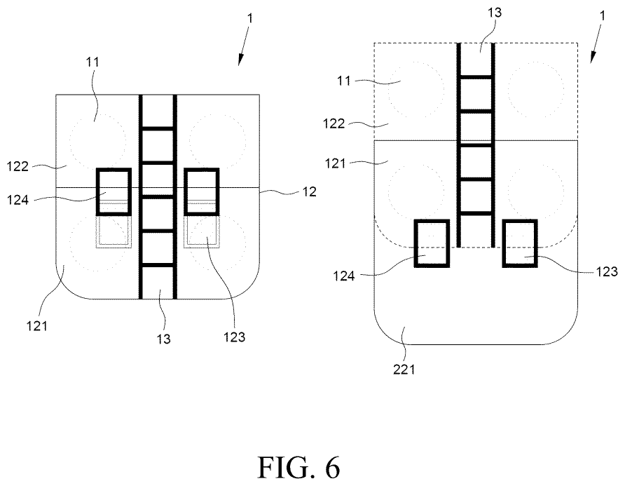

In yet another embodiment, refer to FIG. 6 for a schematic diagram of the placement of the neodymium-iron-boron permanent magnets of the at least two first magnets 123 and the at least two second magnets 124, with the black rectangular box portion being the first magnet 123 permanent magnet on the back cover 22 in the mobile device 2, and the gray block being the second magnet 124 permanent magnet on the movable part 221.

When this embodiment is not slid out, due to the repulsive force between the same poles magnets, the movable part 221 will be pushed up inside the slot, when manually slid out, due to the suction force between the opposite poles magnets, the movable part 221 is also magnetically fixed after sliding out, the movable part 221 is pushed up into the limiting mechanism of the mobile device 2 to ensure that there is no displacement in the vertical sliding direction, and the bold line is the schematic representation of the rotary module 13, when the upper part of the double camera slides out, it can rotate around the rotary module 13 to realize the transformation of the rear camera to the front camera.

In summary, in a camera module and a mobile device provided by the present invention, by seizing the core contradiction that the front camera is difficult to hide, which hinders the development of the full screen, simplifying the sliding structure, only making the camera module into a small sliding module using neodymium-iron-boron permanent magnets, and at the same time adding the rotating mechanism of the rear dual camera, is a low-cost, small occupation of space inside the body, and the structural strength can be guaranteed to realize the full-screen solution.

The above mentioned embodiments are only used to illustrate the technical solutions of the present application, not to limit them; although the application has been described in detail with reference to the foregoing embodiments, the person of ordinary skill in the field should understand that it is still possible to modify the technical solutions documented in the foregoing embodiments, or to replace some of the technical features with equivalent ones; these modifications or replacements do not detach the essence of the corresponding technical solutions from the spirit and scope of the technical solutions of the embodiments of the present application, shall be included in the scope of protection of the present application, such as all the equivalent modifications or changes made by those who have the general knowledge in the field of technology without detaching from the spirit of the spirit of the present invention and the technical ideas disclosed in the present invention, shall still be covered by the claims of the present invention.

1. A camera module used in a mobile device, characterized in:
a camera module, having at least three lenses;
a drive module comprising a transmission mechanism, a limiting mechanism, and a rotary module for connecting the camera module to drive the camera module to make a linear sliding movement and a horizontal rotation movement;
wherein the transmission mechanism drives the rotary module to cause the camera module to make horizontal rotation movement.

2. The camera module of claim 1, characterized in: the transmission mechanism comprising a first transmission unit and a second transmission unit cooperating with the first transmission unit, the limiting mechanism comprises at least two first magnets and at least two second magnets, the at least two first magnets are disposed in the first transmission unit, at least the two second magnets are disposed in the mobile device, the at least two first magnets are disposed side by side with the at least two second magnets, and at least the two first magnets and at least the two second magnets may be close to or far from each other under the effect of magnetic force.

3. The camera module of claim 1, characterized in: the rotary module is provided between the drive modules to connect the first transmission unit and the second transmission unit and to make horizontal rotation movement of the second transmission unit.

4. The camera module of claim 1, characterized in: the camera module is provided with at least a first lens, a second lens, and a third lens, which are combinations of a fixed focal length lens, a zoom lens, a shorter focal length lens, a longer focal length lens, a wide-angle zoom lens, and an ultra-wide-angle lens, respectively; the first lens and the second lens are provided on the second transmission unit; the third lens is provided on the first transmission unit.

5. The camera module of claim 1, characterized in: the camera module further comprises a flashlight, the flashlight being disposed on the first transmission unit.

6. The camera module of claim 1, characterized in: the drive module further comprises a power mechanism, the power unit transmits power through the first transmission unit and the second transmission unit to drive the camera module of the camera module to do a linear sliding movement and a horizontal rotation movement in sequence.

7. The camera module of claim 1, characterized in: wherein the process of the camera module doing linear sliding movement, manually controlling sliding the first transmission unit and the second transmission unit to do linear sliding movement; wherein the process of the camera module doing horizontal rotation movement, manually controlling sliding the first transmission unit to do linear sliding movement, and manually controlling rotating the second transmission unit to do horizontal rotation movement.

8. The camera module of claim 1, characterized in: the limiting mechanism is able of enabling a linear sliding movement of the transmission mechanism between a first position and a second position for realizing the switching of the camera module between a rear-focused state and a front-focused state.

9. The camera module of claim 2, characterized in: at least the two first magnets and at least the two second magnets are, but not limited to, neodymium iron boron permanent magnets.

10. A mobile device, the mobile device using a camera module as described in claim 1, and provided with a display screen and a back cover, characterized in: the back cover comprises a movable part, the display screen is fixedly connected to the back cover, the movable part is connected to the drive module, the camera module is spliced with the back cover to form the outer surface of the mobile device, the drive module is used to drive the camera module in a linear sliding movement and a horizontal rotation movement, so that the camera module has the functions of both a rear camera and a front camera, and during the process of the drive module driving the camera module to lift and lower, the movable part is lifted and lowered synchronously together with the drive module.

11. The mobile device of claim 10, characterized in: the transmission mechanism comprising a first transmission unit and a second transmission unit cooperating with the first transmission unit, the limiting mechanism comprises at least two first magnets and at least two second magnets, the at least two first magnets are disposed in the first transmission unit, at least the two second magnets are disposed in the mobile device, the at least two first magnets are disposed side by side with the at least two second magnets, and at least the two first magnets and at least the two second magnets may be close to or far from each other under the effect of magnetic force.

12. The mobile device of claim 10, characterized in: the rotary module is provided between the drive modules to connect the first transmission unit and the second transmission unit and to make horizontal rotation movement of the second transmission unit.

13. The mobile device of claim 10, characterized in: the camera module is provided with at least a first lens, a second lens, and a third lens, which are combinations of a fixed focal length lens, a zoom lens, a shorter focal length lens, a longer focal length lens, a wide-angle zoom lens, and an ultra-wide-angle lens, respectively; the first lens and the second lens are provided on the second transmission unit; the third lens is provided on the first transmission unit.

14. The mobile device of claim 10, characterized in: the camera module further comprises a flashlight, the flashlight being disposed on the first transmission unit.

15. The mobile device of claim 10, characterized in: the drive module further comprises a power mechanism, the power unit transmits power through the first transmission unit and the second transmission unit to drive the camera module of the camera module to do a linear sliding movement and a horizontal rotation movement in sequence.

16. The mobile device of claim 10, characterized in: wherein the process of the camera module doing linear sliding movement, manually controlling sliding the first transmission unit and the second transmission unit to do linear sliding movement; wherein the process of the camera module doing horizontal rotation movement, manually controlling sliding the first transmission unit to do linear sliding movement, and manually controlling rotating the second transmission unit to do horizontal rotation movement.

17. The mobile device of claim 10, characterized in: the limiting mechanism is able of enabling a linear sliding movement of the transmission mechanism between a first position and a second position for realizing the switching of the camera module between a rear-focused state and a front-focused state.

18. The mobile device of claim 11, characterized in: at least the two first magnets and at least the two second magnets are, but not limited to, neodymium iron boron permanent magnets.
